(19) United States
(12) Patent Application Publication
(10) Pub. No.: US 2004/0135915 A1
(43) Pub. Date: Jul. 15, 2004

(54) Image capturing device having bending optical system

(75) Inventors: Sadanobu Ueda, Osaka (JP); Yoshito Iwasawa, Tokyo (JP); Yoshihiro Hara, Osaka (JP); Akira Kosaka, Osaka (JP); Kazuaki Matsui, Osaka (JP); Satoshi Yokota, Osaka (JP)

Correspondence Address: MCDERMOTT, WILL & EMERY, 600 13th Street, N.W., WASHINGTON, DC, 20005-3096, US

(73) Assignee: MINOLTA CO., LTD.

(21) Appl. No.: 10/449,062

(22) Filed: Jun. 2, 2003

(30) Foreign Application Priority Data
Jan. 10, 2003 (JP) 2003-004035 PAT

(51) Int. Cl. H04N 5/225

(52) U.S. Cl. 348/335

(57) ABSTRACT

A photographing device having a flexion optical system which prevents a user's finger(s) from interfering with a lens opening portion carelessly or unpreparedly, and which allows constituent parts of the photographing device to be arranged effectually inside a body thereof to make it low-profile and compact. The flexion optical system extends fully in a direction of right and left of the body thereof, or fully in a direction of up and down of the body, as the photographing device in a standard posture, or position, is viewed from a side of an object, the image of which is captured by the photographing device.

This application is based upon application No. 2003-4035 filed in Japan, the contents of which are hereby incorporated by reference.

### BACKGROUND OF THE INVENTION

1. Field of the Invention

The present invention generally relates to an image capturing device having a bending optical system (or flexure optical system or flexion optical system), and particularly relates to a camera, as the image capturing device, having the bending optical system, in which an image of an object (or subject) is focussed or formed after an optical axis of light of the object is bent generally perpendicularly.

2. Description of the Related Art

Conventionally, there have been proposed a variety of digital cameras.

For example, Japanese Laid-Open Patent Publication No. 10-253886 discloses an electronic camera which has a camera body equipped with a display device and which has a camera part arranged horizontally on an upper part of the camera body. According to the electronic camera, the optical axis of the camera part is bent by, for example, a mirror; the optical axis thus having been bent extends along a length of the camera body; and the camera part can rotate with respect to a center of the optical axis thus having been bent. In the arrangement, the optical system thereof is not arranged over the full width of the camera body. Also, the publication does not disclose that other parts or components are mounted in parallel with the camera part, and the publication also does not disclose any connecting wire cable.

On the other hand, Japanese Laid-Open Patent Publication No. 11-220646 discloses an electronic camera having a downsized camera body, in which a part, bending the optical axis, of the optical system is rotatable. The electronic camera has a memory card in front of the optical system inside the camera body; and the camera has a liquid crystal display panel behind the optical system therein. In the mechanism, the battery is arranged near a heat radiation plate, or a heatsink, which is attached to an image capturing element, for the purpose of heating the battery. Regarding arrangement of other parts or components, the publication does not disclose that those parts are mounted in parallel with the optical system, and the publication also does not disclose that the camera part is mounted therein by making use of the full width of the camera body.

On the other hand, Japanese Laid-Open Patent Publication No. 9-163206 discloses a small-sized video camera in which a bending optical system is arranged along a side of the recording/playback system. The publication does not disclose that the bending optical system thereof is mounted sideways; it does not disclose in which direction other elements or components are arranged; and it also does not disclose any connecting cable.

On the other hand, there has been provided another low-profile camera, commercially available, in which its bending optical system is arranged vertically at its right side of the camera body when viewed from its front side of the camera body.

There is an increase in demand for a down-sized and low-profile camera, in order to enhance the portability of a camera.

Meanwhile, in comparison with a camera having a simple and single focussing optical system, a camera having a zoom lens or a multi-focussing lens, which can change its image capturing region, is rising in popularity. In the comparison, upon capturing an image of an object, the length of the optical system adopting the zoom lens or the multi-focussing lens, is greater than the length of the optical system adopting the single focussing optical system or single focussing lens. In order to provide the camera with the zoom lens and to make the camera compact, a collapsing type of an optical system is widely used for the camera, no matter whether the camera is using a silver halide film, or the camera performs the operation to record the image of an object electronically.

The image capturing element part of the camera which performs the operation to record the image thereof electronically, is relatively small with respect to the film surface of the silver halide film used for the conventional camera. Also, according to the camera which performs the operation to record the image thereof electronically, there is no need of winding of any film, and/or there is no need of accommodating the film inside the camera body. That is, the freedom for arranging the lens inside the camera body is relatively higher. Therefore, as a compact camera in which the downsizing of the camera body is realized in a way other than the way to employ the collapsing type of the optical system, there has been proposed a camera in which a beam of light (or a luminous flux) is bent at 90° somewhere in the optical system. According to this type of camera, the length of the optical system in the direction in which the lens of the optical system is moved back and forth, is transformed into the length horizontally and vertically. With the mechanism, the thickness of the camera body in the direction in which the lens of the optical system is moved back and forth, is relatively smaller, which enhances the portability of the camera.

Also, there has been proposed a technique that an optical system thus having been bent is rotatably arranged relative to the display part and to the electric power source part of the camera. According to the technique, upon capturing the image of an object, it is possible to change the angle between the camera body and a region, or an area, within which the camera can capture the image of the object.

Generally, as the magnifying power of the zoom lens, or of the multi-focus optical system, for capturing an image of an object, increases, the total length of the optical system becomes greater. Therefore, in a case of a camera in which the bending optical system is installed in a direction of up and down of the camera body, the height of the camera body is inevitably greater as the zooming ratio of the optical system increases, because the length of the optical system becomes greater.

In order to realize the downsizing, or miniaturization, of the camera body employing such an optical system in terms of its volume, there is need of making smaller the sideways or lateral length (i.e. width) of the camera body. However, if the sideways or lateral length of the camera body is reduced excessively, there is a possibility that the right hand or the finger(s) may cover the lens opening part through which the light of an object passes into the image-capturing optical system therein.

### SUMMARY OF THE INVENTION

Therefore, it is an object of the present invention to provide an image capturing device, such as a digital camera for example, having a bending optical system (or flexure optical system, or flexion optical system), which prevents the user's hand or the finger(s) from covering the lens opening part carelessly or unpreparedly upon capturing an image of an object, and which allows constituent elements or components to be arranged effectively inside a body thereof for realizing a compact and low-profile image capturing device.

In accomplishing this and other objects of the present invention, according to one aspect thereof, there is provided an image capturing device comprising: an image capturing element for capturing an image of an object; and a bending optical system for bending an optical axis of a light of the object approximately perpendicularly and for forming the image of the object with respect to the image capturing element, wherein the bending optical system is provided inside a body of the image capturing device, in which the bending optical system extends over a full width, in a direction of right and left, of the body, when the body is in a standard posture and when the body in the standard posture is viewed from a side of the object.

In the construction, the image capturing element has a light receiving surface, and the light receiving surface locates at a position corresponding to the position at which the image of the object is formed, or focussed, by the bending optical system. Generally, in a case that the image capturing device is a digital camera, there is provided a release button for executing the operation to capture, or take, the image of an object, on a side of a top surface of the camera body; and there is provided an opening or hole for fixing a screw of a tripod stand for the camera, on a side of a bottom surface of the camera body. In the standard posture, or position, of the camera, the side of the top surface is the side of up of the camera body; and the side of the bottom surface is the side of down of the camera body. When the camera is in such a standard posture, and when the camera body is viewed from the side of the object, the bending optical system extends over the full width, in the direction of right and left, or in the direction of width, or laterally, inside the camera body. It goes without saying that the construction can apply to another type of camera in which the release button is not mounted on the side of the top surface of the camera body, as well.

By constructing the image capturing device as aforementioned, it is possible to mount a longer bending optical system or unit, such as one in which the focal length is longer, one in which the zooming scale factor is larger, etc. inside the body, by making full use of the width thereof. In other words, with the construction, it is possible to reduce the size, or dimension, of the camera body in the direction of right and left thereof as small as possible.

According to the construction, when a lens opening part guiding a light of the object into the bending optical system is provided on a right part (or a left part) of the body of the image capturing device in the standard posture, and when the user holds a left part (or a right part) of the body by one hand, the user's hand and/or the finger(s) is/are prevented from covering (or obstructing or interfering with) the lens opening part carelessly or unpreparedly.

Also, according to the mechanism, considering the direction, or orientation, in which the bending optical system is arranged inside the body, a compact and low-profile image capturing device is realized by arranging any constituent element or component other than the bending optical system properly inside the body. More specifically, regarding the direction in which the image capturing device is moved back and forth with respect to the object, it is possible to make the dimension, or thickness, of the body of the device small enough to be almost equal to the dimension of the bending optical system.

Generally, when a camera, as the image capturing device, in the standard posture is viewed from the side of the object, the camera with its width (i.e. dimension of side in the direction of right and left) being the largest is more easy to use than the camera with its height (i.e. dimension of side in the direction of up and down) being the largest. Therefore, preferably, the aforementioned construction applies to the camera with its width being the largest.

Preferably, at least one constituent element other than the bending optical system is mounted inside the body so that a length of the at least one constituent element is generally parallel to the optical axis of the light thereof having been bent by the bending optical system.

According to the construction, it is possible to position or arrange a longer component, as the at least one constituent element, inside the body with a high efficiency; thus, leading to a realization of a compact and low-profile image capturing device.

In the above mechanism, for example, the at least one constituent element can include: at least one battery for supplying electricity to the image capturing device; a recording medium for recording image data, as electric signals, into which the image capturing element transforms the image of the object; and a capacitor for a flash device.

In the construction, preferably, there is further provided a grip part which locates at one of ends, in the direction of right and left, of the body, and which projects towards the object, when the body in the standard posture is viewed from the side of the object, wherein the image capturing element, and a circuit board connected to the image capturing element, are mounted inside the grip part.

According to the mechanism, not only the grip part facilitates hold of the body by the user, but also the constituent element(s) can be efficiently mounted inside the body by using a space inside the grip part. Therefore, with the construction, more compact an image capturing device, or a more low-profile image capturing device, is realized.

In the mechanism, for example, the bending optical system can locate approximately centrally in a direction of up and down of the body, when the body in the standard posture is viewed from the side of the object.

In the construction, for example, at least one constituent element can be mounted inside each of the spaces formed up and down inside the body relative to the bending optical system. Namely, in a case that the bending optical system is mounted inside an uppermost part of the body of a camera as an image capturing device, its optical finder and/or its flash device must be arranged resourcefully relative to the body, for example. However, according to the aforementioned construction, it is easy to arrange them relative to the body. In addition, with the construction which allows at least one constituent element to be mounted inside each of the spaces formed up and down inside the body, it is possible to make smaller the thickness, or dimension, of the body thereof in the direction in which the body is moved back and forth with respect to an object, or in the direction of the optical axis of light, incident on the lens opening, of the object. That is, with the construction, a more compact and low-profile image capturing device is realized.

In accomplishing the above objects of the present invention, according to another aspect thereof, there is provided an image capturing device comprising: an image capturing element for capturing an image of an object; a bending optical system for bending an optical axis of a light of the object approximately perpendicularly and for forming the image of the object with respect to the image capturing element; and a plurality of constituent elements other than the bending optical system, wherein the bending optical system is provided centrally inside a body of the image capturing device, in which the bending optical system extends over a full distance in one of a first direction of right and left of the body and a second direction of up and down of the body, when the body is in a standard posture and when the body in the standard posture is viewed from a side of the object, and wherein the plurality of constituent elements are distributed to a pair of spaces which are formed by the bending optical system inside the body.

In the construction, in a case that the bending optical system extends over the full distance or length in the first direction of right and left of the body as the body in the standard posture is viewed from the side of the object, when a lens opening part guiding a light of the object into the bending optical system is provided on a right part (or a left part) of the body of the image capturing device in the standard posture, and when the user holds a left part (or a right part) of the body by one hand, the user's hand and/or the finger(s) is/are prevented from covering (or obstructing or interfering with) the lens opening part carelessly or unpreparedly.

On the other hand, in a case that the bending optical system extends over the full distance or length in the second direction of up and down of the body as the body in the standard posture is viewed from the side of the object, when a lens opening part guiding a light of the object into the bending optical system is provided on an upper part (or a lower part) of the body, and when the user holds a left part, a right part, or both parts, of the body by the hand(s), the user's hand and/or the finger(s) is/are prevented from covering (or obstructing or interfering with) the lens opening part carelessly or unpreparedly.

According to the construction, considering the direction, or orientation, in which the bending optical system is arranged inside the body, a compact and low-profile image capturing device is realized by distributing constituent elements or components other than the bending optical system properly to both sides of the bending optical system inside the body thereof. More specifically, regarding the direction in which the image capturing device is moved back and forth with respect to the object, it is possible to make the dimension, or thickness, of the body of the device small enough to be almost equal to the dimension of the bending optical system.

In the construction, for example, there can be further provided an operation member and a flash device, on an upper part of the body, when the body in the standard posture is viewed from the side of the object; and there can be further provided an electric power source, a control part for controlling image capturing operation and an electric charge device for the flash device, in a lower part of the body, when the body in the standard posture is viewed from the side of the object.

In the construction, preferably, one of ends of the body in the first direction of right and left is held by a user upon capturing the image of the object, wherein there is further provided a lens opening part, wherein when the bending optical system extends over the full distance in the first direction of right and left of the body with the body in the standard posture being viewed from the side of the object, the lens opening part is mounted on the other of ends of the body in the first direction of right and left, and wherein when the bending optical system extends over the full distance in the second direction of up and down of the body with the body in the standard posture being viewed from the side of the object, the lens opening part is mounted on one of ends of the body in the second direction thereof.

In the construction, preferably, there is further provided a connection member for electrically connecting the plurality of constituent elements that are distributed to the pair of spaces which are formed by the bending optical system inside the body, wherein the connection member is arranged near a narrow part of the bending optical system which extends between the image capturing element and a reflection member of the bending optical system.

According to the construction, since the connection member is arranged near the narrow part of the bending optical system extending between the image capturing element and the reflection member of the bending optical system, there is no need of setting aside any additional space for the connection part with respect to the direction of thickness of the body. In other words, with the construction, it is possible to make full use of a space, inside the body, for accommodating the connection part; thus, contributing to a realization of a compact and low-profile image capturing device.

Alternatively, there can be provided a connection member for electrically connecting the plurality of constituent elements that are distributed to the pair of spaces which are formed by the bending optical system inside the body, wherein the connection member is arranged between a reflection member of the bending optical system and the body, as a housing, of the image capturing device.

According to the construction, the space forming between the reflection member and the housing can be employed for accommodating the connection member inside the body. Therefore, with the construction, a compact and low-profile image taking device is realized.

### BRIEF DESCRIPTION OF THE DRAWINGS

This and other objects and features of the present invention will become clear from the following description taken in conjunction with preferred embodiments thereof with reference to the accompanying drawings.

FIG. 1 is a perspective view of a digital camera, as an image capturing device, according to a first embodiment of the present invention.

FIG. 2 is a perspective projection view of the digital camera according to the first embodiment.

FIG. 3 is a perspective view of the digital camera according to a second embodiment of the present invention.

FIG. 4 is a perspective projection view of the digital camera according to the second embodiment.

FIG. 5A is a top perspective projection view showing an arrangement of components, or parts, of the digital camera according to a third embodiment of the present invention.

FIG. 5B is a front perspective projection view showing the arrangement of components, or parts, of the digital camera according to the third embodiment of the present invention.

FIG. 5C is a side perspective projection view showing the arrangement of components, or parts, of the digital camera according to the third embodiment of the present invention.

FIG. 6A is a top perspective projection view showing an arrangement of components, or parts, of the digital camera according to a fourth embodiment of the present invention.

FIG. 6B is a front perspective projection view showing the arrangement of components, or parts, of the digital camera according to the fourth embodiment of the present invention.

FIG. 6C is a side perspective projection view showing the arrangement of components, or parts, of the digital camera according to the fourth embodiment of the present invention.

FIG. 7A is a top perspective projection view showing an arrangement of components, or parts, of the digital camera according to a fifth embodiment of the present invention.

FIG. 7B is a front perspective projection view showing the arrangement of components, or parts, of the digital camera according to the fifth embodiment of the present invention.

FIG. 7C is a side perspective projection view showing the arrangement of components, or parts, of the digital camera according to the fifth embodiment of the present invention.

FIG. 8A is a top perspective projection view showing an arrangement of components, or parts, of the digital camera according to a sixth embodiment of the present invention.

FIG. 8B is a front perspective projection view showing the arrangement of components, or parts, of the digital camera according to the sixth embodiment of the present invention.

FIG. 9A is a side perspective projection view showing an arrangement of components, or parts, of the digital camera according to a seventh embodiment of the present invention.

FIG. 9B is a front perspective projection view showing the arrangement of components, or parts, of the digital camera according to the seventh embodiment of the present invention.

### DETAILED DESCRIPTION OF THE PREFERRED EMBODIMENT

Before a description of preferred embodiments of the present invention proceeds, it is to be noted that like or corresponding parts are designated by like reference numerals throughout the accompanying drawings.

With reference to FIGS. 1 through 9B, the description is made below upon a digital camera, as an image capturing device, according to each of the preferred embodiments of the present invention.

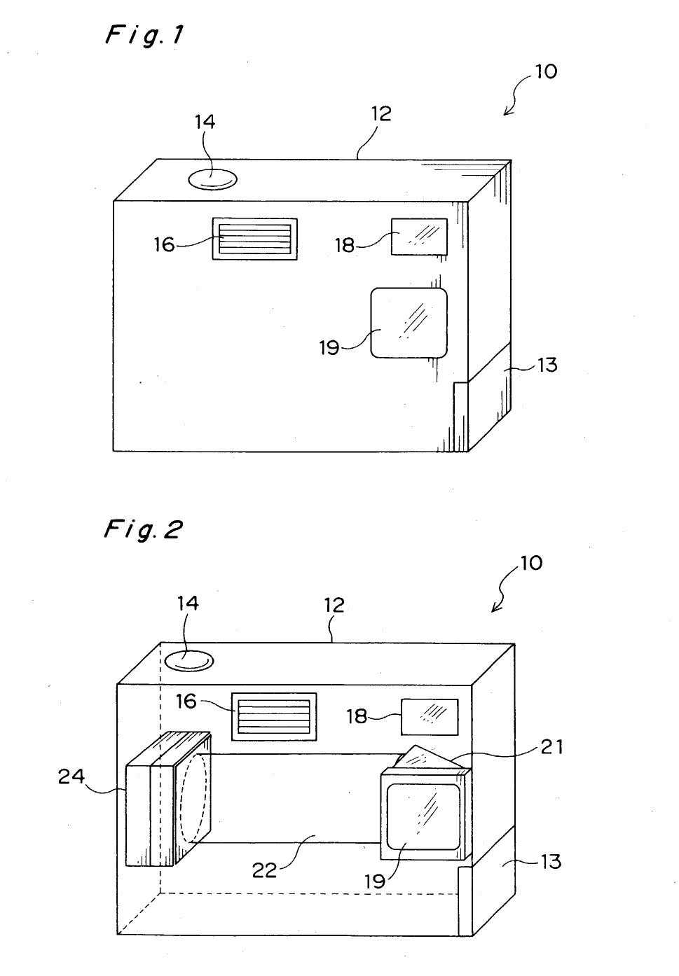

First, with reference to FIGS. 1 and 2, it is explained about the digital camera 10 according to a first embodiment of the present invention.

As shown in FIG. 1, when the digital camera 10 is viewed from a side of an object the image of which is captured or taken, the digital camera 10 in a standard posture or position has a camera body 12, in which a width, or a length, of a side in a lateral direction (i.e. in a direction of right and left in the figure) of the camera body 12 is greater than a thickness, or a length of a side in a direction of thickness of the camera body 12. That is, the camera body 12 is formed low-profile. On a top of the camera body 12, a release button 14, as an operative member, is mounted. On a front of the camera body 12, there are arranged a flash emitting window 16, an optical finder window 18, and a lens opening part 19. On a lateral side (i.e. a right side of the camera body 12 in the figure) of the camera body 12, there is arranged an opening/closing cover 13 for covering an opening, or a hole, of a chamber for accommodating a battery.

As shown in FIG. 2, there is arranged a bending optical unit 22 which is positioned approximately centrally relative to a direction of up and down (i.e. a direction of height) of the camera body 12 and which extends over a full width of the camera body 12. As shown in the figure, the bending optical unit 22 includes a bending optical system, and a triangular prism 21 is arranged on one end (i.e. on the right end in the figure) of the bending optical unit 22, inside the camera body 12. The prism 21 has the function to reflect an incident light, or a beam of light (or a luminous flux), coming from the lens opening part 19, generally at 90° in a horizontal direction (i.e. in the lateral direction, or in the direction of right and left in the figure). Namely, the optical axis of light of an object is bent approximately at 90°, by the prism 21, into the axis towards the left inside the camera body 12.

On the other end (i.e. on the left end in the figure) of the bending optical unit 22, there is arranged an image capturing element 24, such as a CCD. The image of the object is focussed, or formed, on a light receiving surface of the image capturing element 24, through the bending optical system of the bending optical unit 22. There is mounted a field lens (or objective lens), of the bending optical unit 22, between the lens opening part 19 and the triangular prism 21. Although not shown in the figure, the camera body 12 has a lens protection mechanism including a slide barrier. The slide barrier can open and close when a power switch of the digital camera 10 is switched on and off in order to protect the field lens.

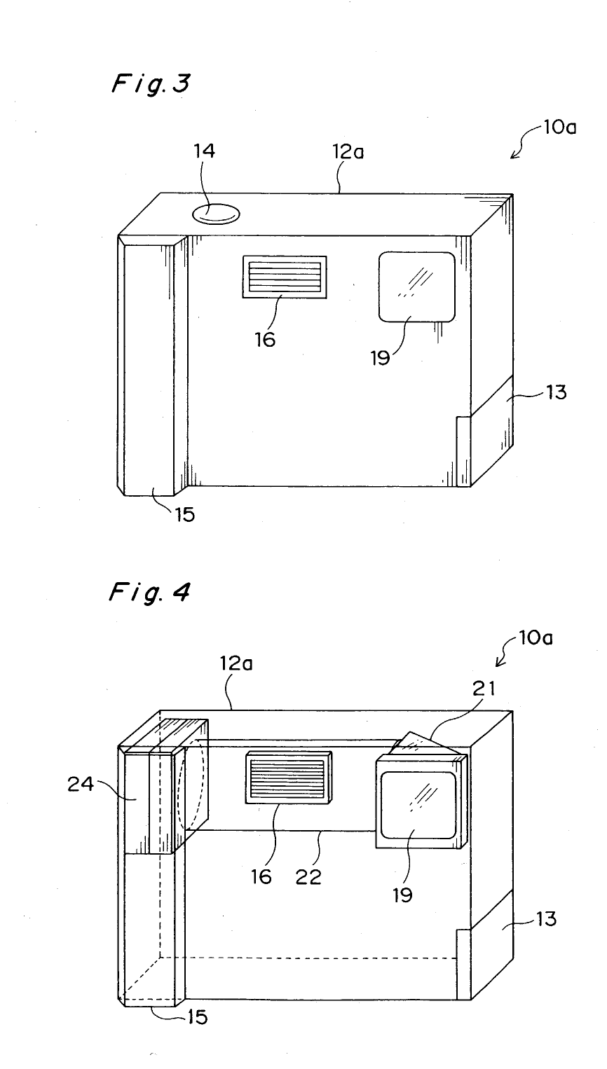

Next, with reference to FIGS. 3 and 4, it is explained about the digital camera 10a according to a second embodiment of the present invention. In the description below of each of the following embodiments of the digital camera, the same constituent part, or component, of the digital camera, is designated by the same reference numeral; and the description is mainly focussed on the difference therebetween.

As shown in FIG. 3, the camera body 12a of the digital camera 10a is low-profile with a lateral side (i.e. a side of width, or a side in the direction of right and left in the figure) being longer than each of other sides thereof. On the left side of the camera body 12a in the figure, the camera body 12a has a grip part 15 which projects ahead towards an object the image of which is captured by this digital camera 10a. On top of the camera body 12a, there is arranged a release button 14. On front (i.e. on the side of the object) of the camera body 12a, there are arranged a flash emitting window 16 and a lens opening part 19. As shown in the figure, the lens opening part 19 is arranged opposite to the grip part 15 in the direction of width (i.e. arranged on the right side of the camera body 12a), in order to prevent the user's hand or the finger(s) from covering the lens opening part 19 when the user holds the camera body 12a. On one side of the camera body 12a, the opening/closing cover 13 for covering a chamber for accommodating a battery, is arranged. On the back side (or rear side) of the camera body 12a, a thin display device like a liquid crystal display panel (not shown in the figure) is arranged so that an image having been captured of an object can be displayed thereon.

As shown in FIG. 4, the bending optical unit 22 is positioned inside an upper part of the camera body 12a so as to extend over the full width of the camera body 12a. On one end (i.e. right end in the figure) of the bending optical unit 22, a triangular prism 21 is mounted. The prism 21 reflect an incident light, from the lens opening part 19, of an object in a horizontal direction; that is, the optical axis of the light of the object is bent approximately at 90° leftwards in the horizontal direction in the figure. On the other end (i.e. left end in the figure) of the bending optical system 22, the image capturing element 24, such as a CCD image capturing element, is mounted. In the arrangement, the image of the object is focussed on the light receiving surface of the image capturing element 24, by the optical system of the bending optical unit 22.

Inside the grip part 15, the image capturing element 24, and a substrate which is connected to the image capturing element 24 (not shown), are mounted. This grip part 15 has the following advantage or merit. Namely, in a case that the image capturing element 24 and/or a part of the substrate connected to the image capturing element 24, project(s) ahead or forward (i.e. on the side of the object) relative to a body of the bending optical unit 22, the projecting part(s) thereof can be housed inside the grip part 15. With the arrangement, it is possible to make the other part of the camera body 12a, except the grip part 15, smaller in thickness than that of the camera body 12 of the first embodiment, thus realizing a low-profile and compact digital camera.

Incidentally, according to the second embodiment, the bending optical unit 22 is arranged inside the upper part of the camera body 12a. As a modification to the second embodiment, the bending optical unit 22 can also be arranged generally centrally in the direction of height of the camera body 12, similar to the first embodiment. In the modification, the image capturing element 24 and the substrate can also be arranged inside the grip part 15.

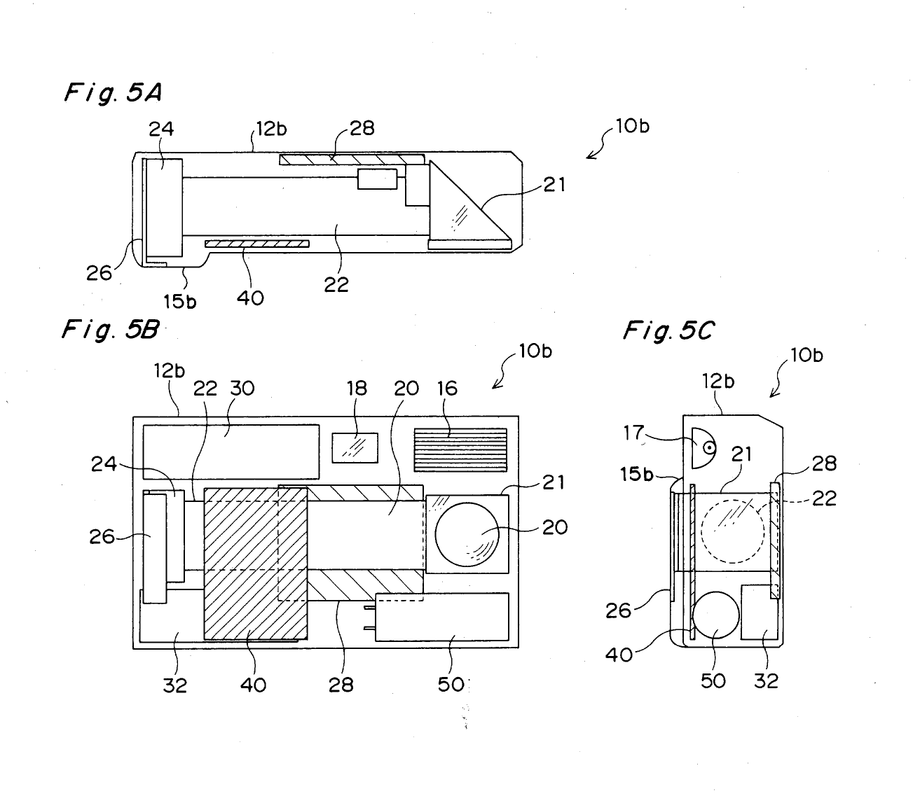

Next, with reference to FIGS. 5A, 5B and 5C, it is explained about the digital camera 10b according to a third embodiment of the present invention.

FIG. 5A is a perspective projection view showing the digital camera 10b from its top side or upper surface thereof; FIG. 5B is a perspective projection view showing the digital camera 10b from its front side or front surface thereof; and FIG. 5C is a perspective projection view showing the digital camera 10b from its right side or right side surface.

As shown in the figures, the bending optical unit 22 is arranged generally centrally in the direction of up and down (i.e. in the direction of height) of the camera body 12b of the digital camera 10b so as to extend fully inside the camera body 12b in the direction of the width of the camera body 12a (i.e. so as to extend fully in the direction of right and left in FIGS. 5A and 5B). An objective lens 20 of the bending optical unit 22 is mounted between its lens opening part and the triangular prism 21. A heatsink (i.e. heat radiation plate) 26 is mounted inside the camera body 12b so as to be adjacent to both of the image capturing element 24 and a housing of the grip part 15b. The heatsink 26 has the function to let heat generated by the image capturing element 24 be released, or radiated, from the grip part 15b towards outside of the camera body 12b. As shown in FIG. 5B, under the bending optical unit 22 inside the camera body 12b, there are arranged a rectangular parallelepiped rechargeable battery pack 32, as a secondary battery, and a main capacitor 50 for a flash device. Above the bending optical unit 22, there are arranged an optical finder window 18, a flash emitting window 16, and a flash emitting part 17. There is also arranged a slot part for loading (not shown), or installing, a recording medium 30, above the bending optical unit 22. The bending optical unit 22, the battery pack 32, the main capacitor 50, the recording medium 30 which is inserted into the slot part, and a xenon lamp (or xenon bulb) of the flash emitting part 17, are arranged so that the lengths thereof are parallel to each other in the direction of right and left of the camera body 12b in the figures.

That is, when they are shown from the front part of the camera body 12b, the flash emitting part 17 and the main capacitor 50 for the flash device, which can not be exchanged by the user, are mounted on the right side of the camera body 12b in the figure; and the slot part for letting the recording medium 30, which the user can exchange with another, to be inserted therein, and a chamber for accommodating the battery pack 32, are mounted on the left side thereof in the figure. The arrangement contributes to enhancement of efficiency of making use of a space inside the camera body 12b.

As shown in the figures, a hard substrate 40 for electric connection is mounted on the front part inside the camera body 12b; and a display device 28, such as a liquid crystal display panel, is mounted on the back part (or rear part) inside the camera body 12b. The hard substrate 40 for electric connection, electrically connects the flash emitting part 17 and the recording medium 30, both positioning above the bending optical unit 22, to the rechargeable battery pack 32 and the main capacitor 50 for the flash device, both positioning under the bending optical unit 22.

As a modification to the third embodiment, the hard substrate 40 for electric connection can include a control device for the digital camera.

Although not shown in the figures illustrating the digital camera according to the third embodiment and the digital camera according to each of the following fourth through seventh embodiments, a release button for operating the digital camera locates on top of the camera body.

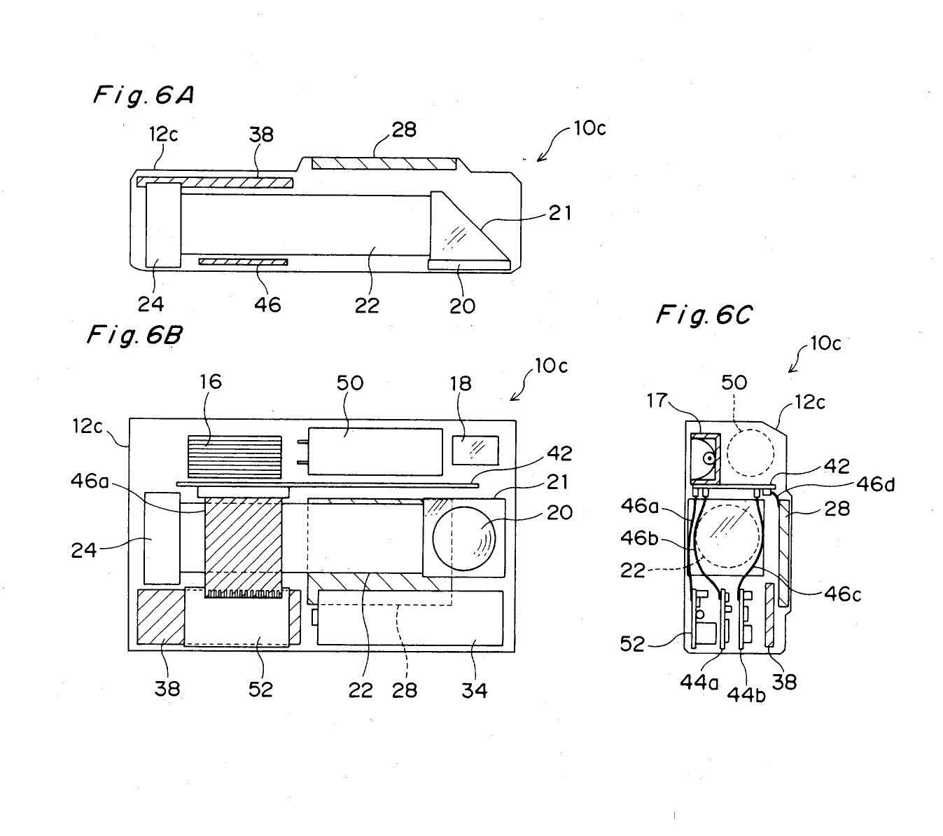

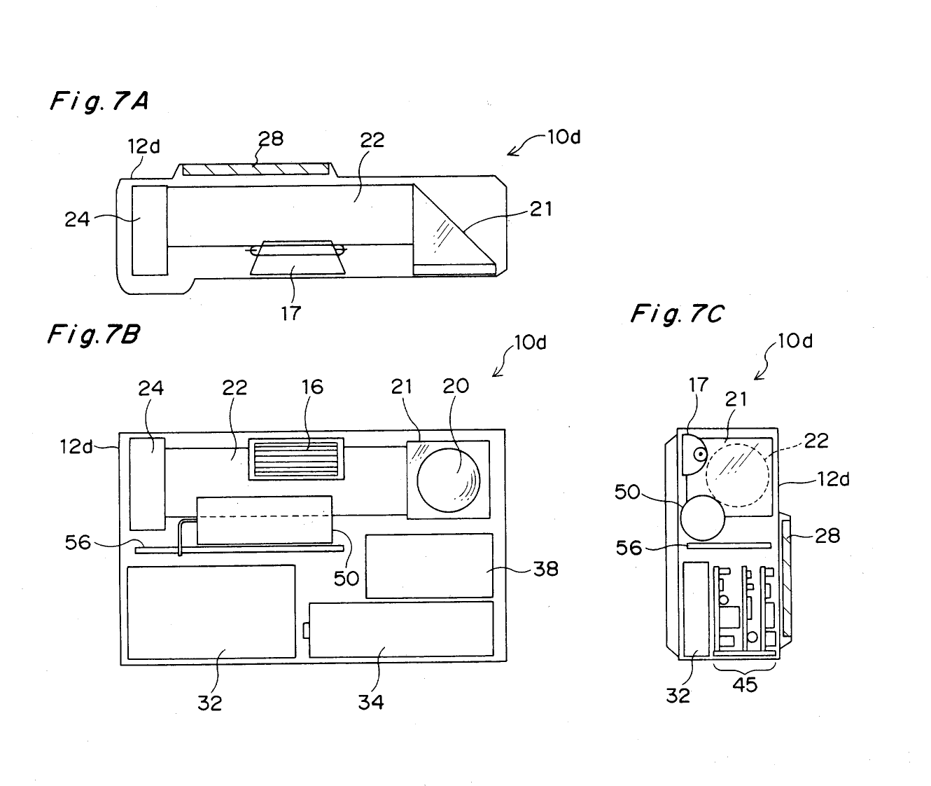

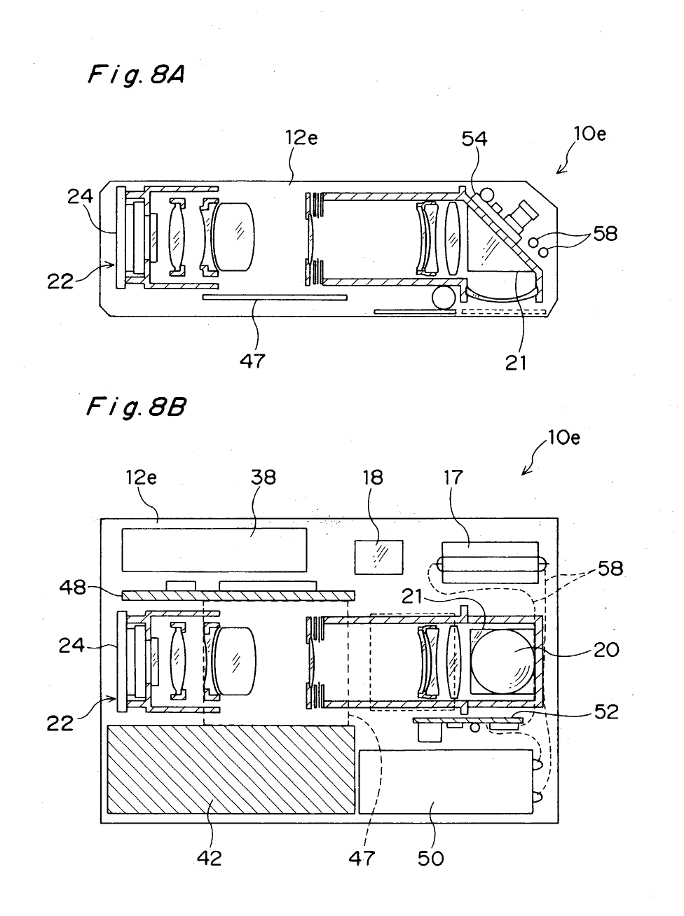

Next, with reference to FIGS. 6A through 6C, it is explained about the digital camera 10c according to a fourth embodiment of the present invention.

FIG. 6A is a perspective projection view showing the digital camera 10c from its top side or upper surface; FIG. 6B is a perspective projection view showing the digital camera 10c from its front side or front surface; and FIG. 6C is a perspective projection view showing the digital camera 10c from its right side or right side surface.

As shown in the figures, the bending optical unit 22 is arranged approximately centrally in the direction of up and down (i.e. direction of height) of the camera body 12c of the digital camera 10c so as to extend fully inside the camera body 12c in the direction of the width of the camera body 12a (i.e. so as to extend fully in the direction of right and left in the figures).

Inside a lower part of the camera body 12c, there are arranged a slot part (not shown) into which the recording medium 38 such as a memory stick, is inserted or loaded, an electric charging circuit substrate (or board) 52 for the flash device, other circuit substrates (or boards) 44a and 44b, and a battery chamber (not shown) for housing a pair of exchangeable dry cell batteries 34 each of which is column-shaped, so that they are parallel with a direction of the length of the bending optical unit 22 (i.e. in the direction of right and left in FIGS. 6A and 6B).

Behind the bending optical unit 22, there is arranged a thin display device 28, such as a liquid crystal display panel.

Immediately above the bending optical unit 22, there is arranged a control circuit substrate (or board) 42 horizontally inside the camera body 12c. The length of the substrate 42 is approximately equal to, or more than, 70% of the total width (i.e. of length in the direction of right and left in FIG. 6B) of the camera body 12c. There are mounted electronic components or elements on the control circuit substrate (or board) 42.

Above the control circuit substrate 42, there are arranged a flash emitting part 17 and a main capacitor 50 for the flash device. The xenon lamp (or xenon bulb) of the flash emitting part 17 and the main capacitor 50 for the flash device, are arranged so that each of the lengths thereof is parallel with the length of the bending optical unit 22 (i.e. with the direction of width of the camera body 12c, or with the direction of right and left in FIGS. 6A and 6B).

The control circuit substrate 42 is electrically connected to the electric charging circuit substrate 52 for the flash device, the other circuit substrates 44a and 44b, a display device 28, and each of the flexible substrates (or flexible boards) 46a, 46b, 46c and 46d. The control circuit substrate 42 functions not only as a control part, but also as a relay part for realizing electric connections therebetween.

The flexible substrates 46a, 46b and 46c are arranged inside the camera body 12c, by making use of a space or gap which is adjacent to a narrower part (i.e. a part corresponding to a part where there is not arranged a group of movable lenses and to the part where the optical path is narrower) of the bending optical unit 22.

Next, with reference to FIGS. 7A through 7C, it is explained about the digital camera 10d according to a fifth embodiment of the present invention.

As shown in FIGS. 7B and 7C, the bending optical unit 22 is arranged on an upper part inside the camera body 12d of the digital camera 10d so as to extend fully inside the camera body 12d in the direction of the width of the camera body 12d (i.e. so as to extend fully in the direction of right and left in FIGS. 7A and 7B). On one end (i.e. On the right side in each of FIGS. 7A and 7B) of the bending optical system 22, there is arranged a prism 21 for reflection; and on the other end (i.e. on the left side in each of the same figures), there is arranged an image capturing element 24.

Inside the lower part of the camera body 12d, there are arranged a slot part (not shown) into which a recording medium 38, such as a memory stick, is inserted or loaded; a rechargeable battery pack 32, as a secondary battery, which is rectangular parallelepiped in shape; a circuit substrate (or board) 45; a battery chamber (not shown) for housing a pair of exchangeable dry cell batteries, each of which is column-shaped; and an electric charging circuit substrate 56 for the flash device. These components or elements are mounted inside the camera body 12d so as to be parallel with the length of the bending optical unit 22 (i.e. with the direction of width of the camera body 12d, or with the direction of right and left in FIGS. 7A and 7B).

As shown in FIG. 7C, there are mounted the flash emitting part 17 including a light reflector and a main capacitor 50 which is mounted on the electric charging circuit substrate 56 for the flash device, in a space or gap which forms between a lens barrel part, extending between the prism 21 and the image capturing element 24, of the bending optical unit 22 and an outer cover of the camera body 12d, thus possible to effectively make use of the space or gap around the lens barrel part of the bending optical unit 22.

Next, with reference to FIGS. 8A and 8B, it is explained about the digital camera 10e according to a sixth embodiment of the present invention.

FIG. 8A is a perspective projection view showing the digital camera 10e from its top side or upper surface; and FIG. 8B is a perspective projection view showing the digital camera 10e from its front side or front surface.

As shown in FIG. 8B, the bending optical unit 22 is arranged generally centrally in the direction of up and down of the camera body 12e of the digital camera 10e so as to extend fully inside the camera body 12e in the direction of the width of the camera body 12e (i.e. so as to extend fully in the direction of right and left in the figures).

Below the bending optical unit 22 inside the camera body 12e, there are arranged an electric charging circuit substrate (or board) 52 for the flash device, a main capacitor 50 for the flash device, a control circuit substrate 42, and a battery pack (not shown), so as to be parallel with the length of the bending optical unit 22 (i.e. with the direction of width of the camera body 12e, or with the direction of right and left in the figures).

Above the bending optical unit 22 inside the camera body 12e, there are arranged a slot part (not shown) into which a recording medium 38, such as a memory stick, is inserted or loaded, a flash emitting part 17, and another circuit substrate (circuit board) 48, so as to be parallel with the direction of the length of the bending optical unit 22 (i.e. with the direction of width of the camera body 12e, or with the direction of right and left in the figures).

There is arranged a flexible substrate (or flexible board) 47 for electric connection on a front side inside the camera body 12e. The flexible substrate 47 therefor electrically connects the control circuit substrate 42 locating below relative to the bending optical unit 22 and the circuit substrate 48 locating above relative thereto to each other.

As shown in FIG. 8B, the electric charging circuit substrate 52 for the flash device is positioned immediately above the main capacitor 50, in which arrangement the circuit substrate 52 can execute the operation to electrically charge the main capacitor 50. Upon capturing an image of an object, the electric energy stored in the main capacitor 50 is discharged to the xenon lamp (or xenon bulb) of the flash emitting part 17 through a lead wire (i.e. electrically conductive lead) 58 which connects both of them to each other.

As shown in FIG. 8A, the lead wire 58 extends in a space or gap behind the prism 21 of the bending optical unit 22; namely, the wire 58 passes in the back space (or rear space) locating opposite to the optical axis of the prism 21. As shown in FIG. 8A, a flash trigger circuit substrate (or flash trigger circuit board) 54 is mounted on a back surface (or rear surface), locating opposite to the optical axis of the prism 21. The flash trigger circuit substrate 54 includes an IGBT for controlling amount of the light emission, and it also includes a trigger coil.

According to the construction of the digital camera of each of the six embodiments, the loop (looping circuit) for the flash device through which a large amount of electric current passes or flows, is arranged in a space or gap forming between the prism 21 of the bending optical unit 22 and an outer cover of the camera body 12e. Therefore, with the construction, not only an efficient layout of the components or elements positioned inside the camera body 12e is realized, but also a possible noise generated upon emitting the flash light can be effectively reduced with a separation between the control circuit substrate 42 and the loop for the flash device.

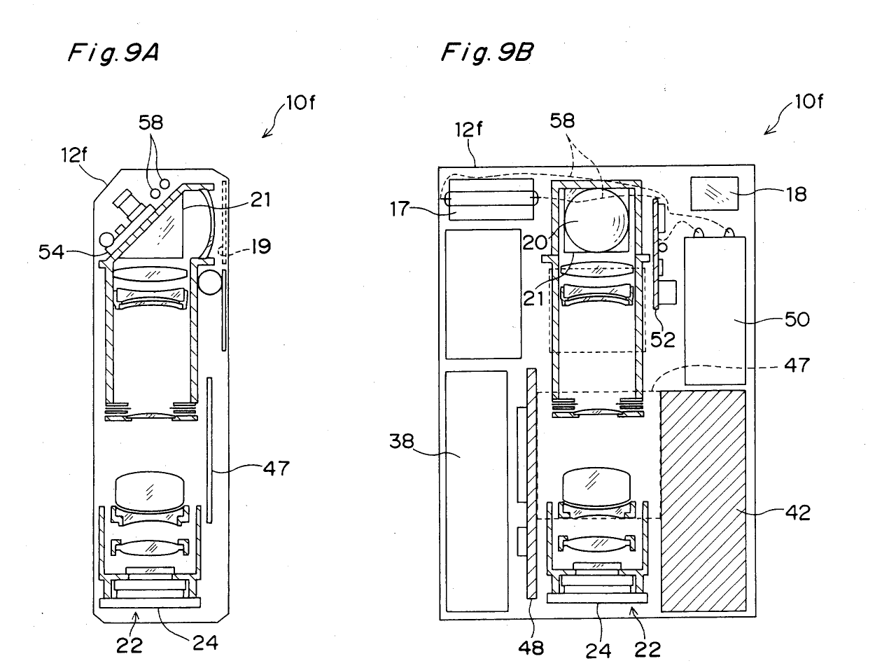

Next, with reference to FIGS. 9A and 9B, it is explained about the digital camera 10f according to a seventh embodiment of the present invention.

FIG. 9A is a perspective projection view showing the digital camera 10f from its side surface; and FIG. 9B is a perspective projection view showing the digital camera 10f from its front side or front surface.

Different from the digital camera according to each of the aforementioned embodiments, the camera body 12f of the digital camera 10f is low-profile in shape with the length of its vertical side (i.e. the height of the camera body 12f, or the length of the side in the direction of up and down of the camera body 12f in the figures) being greater than that of each of the other sides thereof. Inside the camera body 12f, the bending optical unit 22 is mounted vertically, or in the direction of up and down of the camera body 12f. A front upper central part of the camera body 12f has a lens opening part 19. The light of an object passes through the lens opening part 19, and the light is reflected by the prism 21 locating inside the upper central part of the camera body 12f, in a downward direction. The image of the object thus having been reflected by the prism 21 is focussed on a light receiving surface of an image capturing element 24 which is mounted generally centrally on a bottom part inside the camera body 12f. As apparent from the above explanation, the bending optical unit 22 bends the optical axis of the light of, or from, an object downwards (i.e. towards the lower part of the camera body 12f, or towards the bottom part thereof), generally with an angle of 90°. The dimension of the bending optical unit 22 in the vertical direction (i.e. in the direction of up and down of the camera body 12f) is generally equal to the height of the camera body 12f; and the bending optical unit 22 extends fully inside the camera body 12f in the vertical direction.

As shown in FIG. 9B which is the front perspective projection view of the digital camera 10f, constituent components are mounted on both sides of the bending optical unit 22 in the direction of width of the camera body 12f.

Namely, as shown in the same figure, on the right side of the bending optical unit 22, an electric charging circuit substrate 52 for the flash device, a main capacitor 50 for the flash device, and a control circuit substrate 42, are mounted in parallel with the direction of length of the bending optical unit 22 (i.e. with the direction of height of the camera body 12f, or with the direction of up and down in the figure). Also, an optical finder window 18 is mounted on the right side of the optical unit 22.

On the other hand, on the left side of the bending optical unit 22, a slot part (not shown) into which a recording medium 38 such as a memory stick is inserted or loaded, and another circuit substrate (or circuit board) 48, are mounted in parallel with the direction of length of the optical unit 22 (i.e. with the direction of height of the camera body 12f, or with the direction of up and down in the figure). Also, a flash emitting part 17 is mounted on the left side of the optical unit 22.

Inside the front part of the camera body 12f, there is arranged a flexible substrate 47 which electrically connects the control circuit substrate 42 on the right side thereof and another circuit substrate 48 on the left side thereof to each other.

As shown in FIG. 9B, the electric charging circuit substrate 52 for the flash device is very close in location to the main capacitor 50, and the electric charging circuit substrate 52 can charge electricity to the main capacitor 50. Upon capturing, or taking, an image of an object, the electric energy stored on the main capacitor 50 is discharged to the xenon lamp (or xenon bulb) of the flash emitting part 17, via a lead wire which connects the main capacitor 50 and the xenon lamp to each other.

As shown in FIG. 9A, the aforementioned lead wire 58 extends, or passes, in a space or gap forming behind the prism 21 of the bending optical unit 22. A flash trigger circuit substrate 54 is mounted on a rear surface (or back surface) of the prism 21. On the flash trigger circuit substrate 54, there are mounted a trigger coil and an IGBT for controlling the amount of flash light emission.

According to the construction of the digital camera of the seventh embodiment, the loop (looping circuit) for the flash device through which a large amount of electric current passes or flows, is arranged in a space or gap forming between the prism 21 of the bending optical unit 22 and an outer cover of the camera body 12f. Therefore, with the construction, not only an efficient layout of the components or elements positioned inside the camera body 12f is realized, but also a possible noise generated upon emitting the flash light can be effectively reduced with a separation between the control circuit substrate 42 and the loop for the flash device.

According to the construction of each of the aforementioned digital cameras 10, 10a, 10b, 10d, 10e and 10f, the constituent elements or components are effectively arranged inside the camera body 12, 12a, 12b, 12c, 12d, 12e, 12f. Therefore, with the construction or mechanism, upon capturing an image of an object, it is possible to prevent the user's hand and/or the finger(s) from covering the lens opening part of the camera body carelessly or unpreparedly, and it is possible to realize a compact and low-profile digital camera.

Although the present invention has been fully described in connection with the preferred embodiments thereof with reference to the accompanying drawings, it is to be noted that various other changes and modifications are also apparent to those skilled in the art.

For example, instead of employing the prism 21, it is also possible to employ a reflection mirror in order to bend the optical axis thereof.

Such changes and modifications are to be understood as included within the scope of the present invention as defined by the appended claims unless they depart therefrom.

What is claimed is:

1. An image capturing device comprising:
an image capturing element for capturing an image of an object; and
a bending optical system for bending an optical axis of a light of the object approximately perpendicularly and for forming the image of the object with respect to the image capturing element,
wherein the bending optical system is provided inside a body of the image capturing device, in which the bending optical system extends over a full width, in a direction of right and left, of the body, when the body in a standard posture is viewed from a side of the object.

2. The image capturing device as claimed in claim 1, wherein at least one constituent element other than the image capturing element and the bending optical system is mounted inside the body so that a length of the at least one constituent element is approximately parallel to the optical axis of the light thereof having been bent by the bending optical system.

3. The image capturing device as claimed in claim 2, wherein the at least one constituent element includes:
at least one battery for supplying electricity to the image capturing device;
a recording medium for recording image data, as electric signals, into which the image capturing element transforms the image of the object; and
a capacitor for a flash device.

4. The image capturing device as claimed in claim 1, which further comprises a grip part which locates at one of ends, in the direction of right and left, of the body, and which projects towards the object, when the body in the standard posture is viewed from the side of the object,
wherein the image capturing element, and a circuit board connected to the image capturing element, are mounted inside the grip part.

5. The image capturing device as claimed in claim 2, wherein the bending optical system locates approximately centrally in a direction of up and down of the body, when the body in the standard posture is viewed from the side of the object.

6. An image capturing device comprising:
an image capturing element for capturing an image of an object;
a bending optical system for bending an optical axis of a light of the object approximately perpendicularly and for forming the image of the object with respect to the image capturing element; and
a plurality of constituent elements other than the image capture element and the bending optical system,
wherein the bending optical system is provided centrally inside a body of the image capturing device, in which the bending optical system extends over a full distance in one of a first direction of right and left of the body and a second direction of up and down of the body, when the body in a standard posture is viewed from a side of the object, and
wherein the plurality of constituent elements are distributed to a pair of spaces which are formed by the bending optical system inside the body.

7. The image capturing device as claimed in claim 6, which further comprises an operation member and a flash device, on an upper part of the body, when the body in the standard posture is viewed from the side of the object; and which further comprises an electric power source, a control part for controlling image capturing operation and an electric charge device for the flash device, in a lower part of the body, when the body in the standard posture is viewed from the side of the object.

8. The image capturing device as claimed in claim 6, wherein one of ends of the body in the first direction of right and left is held by a user upon capturing the image of the object,
wherein there is further provided a lens opening part,
wherein when the bending optical system extends over the full distance in the first direction of right and left of the body with the body in the standard posture being viewed from the side of the object, the lens opening part is mounted on the other of ends of the body in the first direction of right and left, and
wherein when the bending optical system extends over the full distance in the second direction of up and down of the body with the body in the standard posture being viewed from the side of the object, the lens opening part is mounted on one of ends of the body in the second direction thereof.

9. The image capturing device as claimed in claim 6, which further comprises:
a connection member for electrically connecting the plurality of constituent elements that are distributed to the pair of spaces which are formed by the bending optical system inside the body,
wherein the connection member is arranged near a narrow part of the bending optical system which extends between the image capturing element and a reflection member of the bending optical system.

10. The image capturing device as claimed in claim 6, which further comprises:
a connection member for electrically connecting the plurality of constituent elements that are distributed to the pair of spaces which are formed by the bending optical system inside the body,
wherein the connection member is arranged between a reflection member of the bending optical system and the body, as a housing, of the image capturing device.
